(19) United States
(12) Patent Application Publication
(10) Pub. No.: US 2018/0158161 A1
(43) Pub. Date: Jun. 7, 2018

(54) LICENSE MANAGEMENT SYSTEM, LICENSE MANAGEMENT METHOD, INFORMATION PROCESSING APPARATUS AND STORAGE MEDIUM

(71) Applicant: CANON KABUSHIKI KAISHA, Tokyo (JP)

(72) Inventor: Naoto Yuki, Kawasaki-shi (JP)

(21) Appl. No.: 15/829,738

(22) Filed: Dec. 1, 2017

(30) Foreign Application Priority Data
Dec. 7, 2016 (JP) 2016-237831

(51) Int. Cl. G06Q 50/18; H04L 12/14; H04L 29/08; H04N 1/00

(52) U.S. Cl. CPC G06Q 50/184; H04L 12/1439; H04N 2201/0094; H04N 1/00344; H04L 67/34

(57) ABSTRACT

In a case where a second license for an application corresponding to a first license that is issued based on license information is to be issued based on different license information including a licensed period continuous to the licensed period of the first license, a usage period is set such that the ending time of the first license can be continuous to the starting time of the second license to issue the second license.

### BACKGROUND OF THE INVENTION

### Field of the Invention

The present invention relates to a license management technology, and it particularly relates to a license management system, a license management method, an information processing apparatus, and a storage medium.

### Description of the Related Art

Basic functions such as copy, print and scan functions are normally installed in an image forming apparatus, and an extended function may optionally be provided in the image forming apparatus. Generally, in order to use such an extended function, a user may purchase a product of the extended function. A subscription model is available for purchase of a product of an extended function, and a user may continuously pay a charge to use the function for a licensed period. Japanese Patent Laid-Open No. 2013-250997 discloses a license management system in which a server periodically issues a license based on an initial licensed period, and an apparatus may automatically obtain the license from the server. Such a license management system may be provided to provide a mechanism for updating a license in the apparatus without through a manual operation.

### SUMMARY OF THE INVENTION

According to an aspect of the present invention, a license management system for managing a license for an application to be executed by an image forming apparatus includes a license information storage unit configured to store license information including a licensed period for permitting to use the application, and a license issuing unit configured to issue a license for the application having a usage period set based on the license information. In a case where a second license for an application corresponding to a first license that is issued based on license information is to be issued based on different license information including a licensed period continuous to the licensed period of the first license, the license issuing unit sets a usage period such that the ending time of the first license can be continuous to the starting time of the second license to issue the second license.

Further features of the present invention will become apparent from the following description of exemplary embodiments with reference to the attached drawings.

### BRIEF DESCRIPTION OF THE DRAWINGS

FIG. 1 illustrates a network configuration.

FIGS. 2A and 2B illustrate hardware configurations.

FIGS. 3A and 3B illustrate software configurations.

FIGS. 4A and 4B illustrate data structures of a file.

FIG. 5A is a flowchart illustrating processing to be executed by a usage information registration request receiving unit.

FIG. 5B is a flowchart illustrating processing to be executed by the usage information registration request receiving unit.

FIG. 5C is a flowchart illustrating processing to be executed by the usage information registration request receiving unit.

FIG. 5D is a flowchart illustrating processing to be executed by the usage information registration request receiving unit.

FIGS. 6A and 6B are flowcharts illustrating processing to be executed by a license issuing unit.

FIGS. 7A and 7B are flowcharts illustrating processing to be executed by an image forming apparatus.

### DESCRIPTION OF THE EMBODIMENTS

Generally, a plurality of extended functions supported by apparatuses is available. Those extended functions are available as products, and a plurality of extended functions is provided as one product. A product including a plurality of extended functions is available more inexpensively than a product of each of the extended functions. Therefore, some customers may shift from usage of one product of an extended function to usage of a product of a plurality of extended functions including the extended function. Alternatively, customers may shift from a product product including one certain extended function. Japanese Patent Laid-open No. 2013-250997, however, has problems that change of an product before expiration of such an extended function is not considered and that the corresponding license is not enabled to be automatically updated.

The present embodiment is made for solving the problems and provides a license management system which, in a case where a product is changed while continuing usage of one extended function, enables to automatically update the license of the function.

### Definitions of Terms

Embodiments of the present invention will be described below with reference to drawings. Terms will be defined first.

A term “application file” refers to a file storing a program being an extended function for an image forming apparatus. An application file is not normally held in an image forming apparatus but is stored in a hard disk in an image forming apparatus as required. In order to install or use an application file, a license, which will be described below, is required.

A term “license” refers to a file for permitting installation or usage of an application file in an image forming apparatus. A license may be periodically issued based on a licensed period in usage information, which will be described below. A license is issued every month according to an embodiment but may be issued every certain period.

### System Configuration

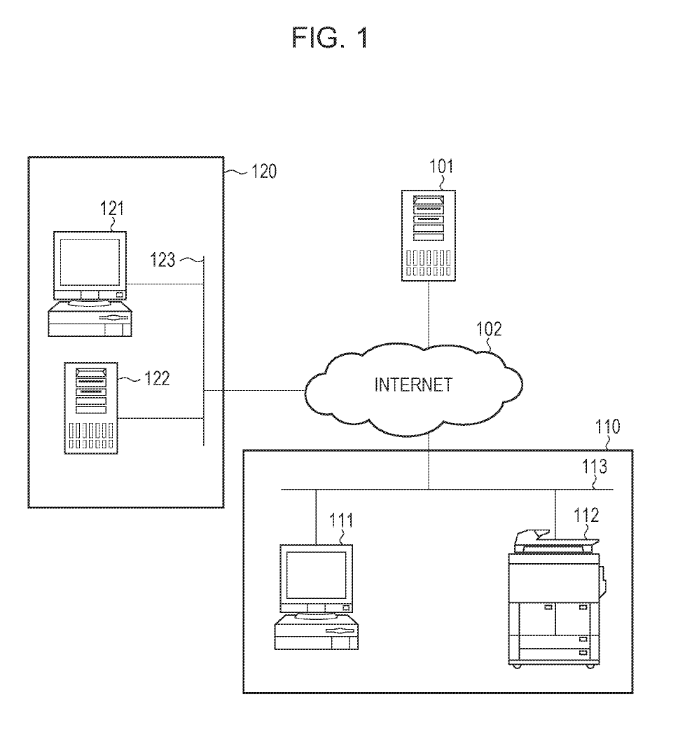

FIG. 1 illustrates a network configuration of a license management system. A license server 101 is a server which can issue a license and can communicate with an apparatus over the Internet 102. One image forming apparatus 112 such as a multi-function peripheral (MFP), one information processing apparatus 111, and one information processing apparatus 121 are connected to the network in the example in FIG. 1, but a plurality of apparatuses may be provided.

A customer network environment 110 is a network environment of a customer who has purchased the image forming apparatus 112. In the customer network environment 110, the image forming apparatus 112 and the information processing apparatus 111 are connected over a LAN (local area network) 113. The LAN 113 is connectable to the Internet 102. A distributor network environment 120 is a network environment for a distributor who sells an extended function. In the distributor network environment 120, the information processing apparatus 121 and a license server 122 are connected over a LAN 123. The LAN 123 is connectable to the Internet 102.

In the configuration, a user of the image forming apparatus 112 may use an application included in a licensed product to use an extended function. Some applications may be used alone, for example, in the image forming apparatus 112, and some applications may support a service provided by an application server. For example, such an application may be downloaded to the image forming apparatus 112, and a license for the application may be downloaded. Thus, the corresponding application is usable for a period (licensed period) associated with the license. According to this embodiment, in a case where the application is under a long licensed period, the license divided into licensed periods each equal to one month may be updated until expiration of the licensed period. The term, “long term” refers to a period which ends at the date of end. of a license after the end of the next month of the month including the date of start of the license or the start of the period. According to this embodiment, a license may start from the first day of a month and end at the last day of the month, and a licensed period may be set arbitrarily or in other units such as weeks and years.

### Hardware

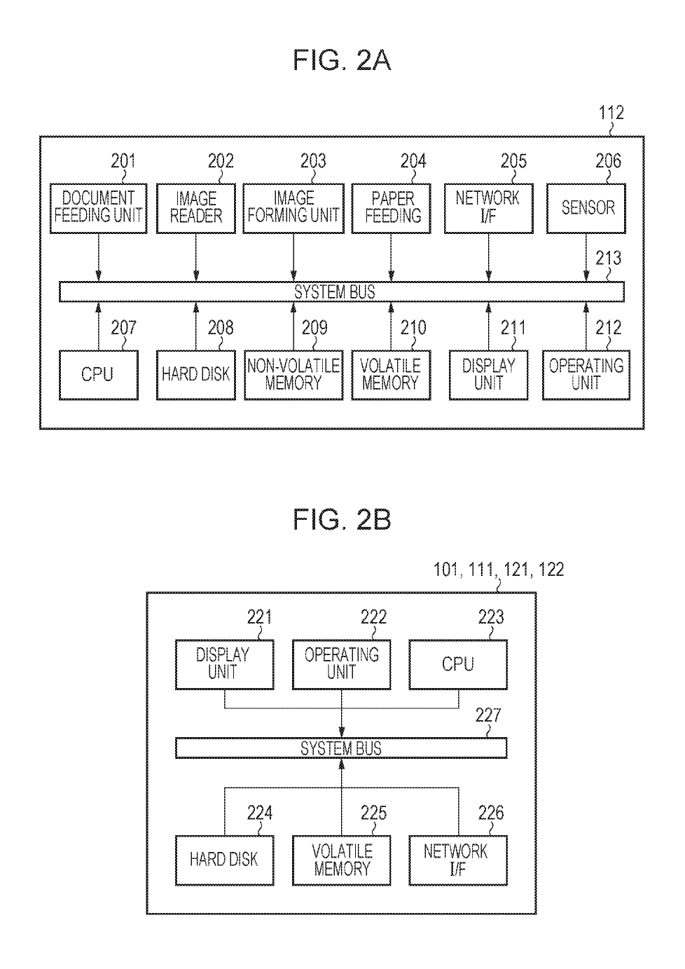

FIGS. 2A and 2B illustrate hardware configurations of a license management system. FIG. 2A illustrates a hardware configuration of the image forming apparatus 112, and FIG. 2B illustrates a hardware configuration of the information processing apparatuses 111 and 121, the license server 122, and the license server 101.

As illustrated in FIG. 2A, the image forming apparatus 112 includes the following components 201 to 213. A document feeder 201 is configured to automatically feed a document to be read to an image reader 202. An image reader 202 (such as a scanner) is configured to read a document fed thereto. An image forming unit 203 is configured to convert a read document and received data to a print image and print it. A feeding unit 204 is configured to feed paper for printing. A network I/F (interface) 205 is connected to the LAN 113 and the Internet 102 over a network and is configured to exchange information with an external apparatus. A sensor 206 is configured to detect states of the components of the apparatus. A CPU 207 is configured to control over processing in the apparatus. A hard disk 208 is configured to store a program and data associated with processes to be performed in the apparatus. A non-volatile memory 209 is a rewritable memory which can hold data stored therein without power supply and may be an FRAM (Ferroelectric Random Access Memory). A volatile memory 210 is a rewritable memory which can electrically store temporary data associated with processes to be performed in the apparatus. A display unit 211 is configured to display information regarding operation conditions of the apparatus and operations performed on an operating unit 212. The operating unit 212 is configured to receive an instruction input to the apparatus. A system bus 213 is configured to connect the components 201 to 212 and exchange data.

As illustrated in FIG. 2B, each of the information processing apparatuses 111 and 121, the license server 122, and the license server 101 includes the following components 221 to 227. A display unit 221 is configured to display a window, an icon, a message, a menu, and other user interface information. An operating unit 222 is configured to input from an end user using a keyboard and a mouse. A CPU 223 is configured to control over processes to be performed in the apparatus. A hard disk 224 is configured to store programs and data associated with processes to be performed in the apparatus. A volatile memory 225 is a rewritable memory which can electrically store temporary data associated with processes to be performed in the apparatus. A network I/F 226 is connected to the LANs 113 and 123 and the Internet 102 and is configured to exchange information with an external apparatus. A system bus 227 is configured to connect the components 221 to 226 and exchange data.

### Software in License Server

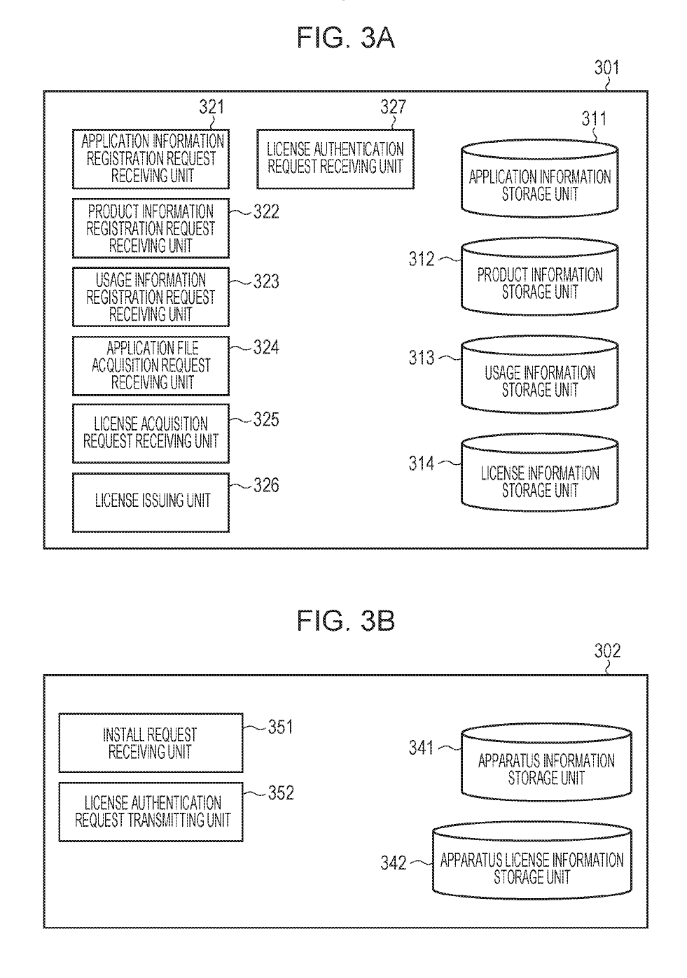

FIGS. 3A and 3B illustrate software configurations of the license management system. FIG. 3A illustrates a software configuration 301 of the license server 101, and FIG. 3B illustrates a software configuration 302 of the image forming apparatus 112. Components of the software configuration 301 in FIG. 3A may be executed by the CPU 223 by loading programs stored in the hard disk 224 to the volatile memory 225 in the license server 101.

An application information storage unit 311 is configured to store application information tables in the hard disk 224 in the license server 101. Table 1 illustrates an example application information table stored in the application information storage unit 311.

TABLE 1

| APPLICATION | APPLICATION | APPLICATION |
|---|---|---|
| ID | NAME | FILE PATH |
| A001 | Scan APPLICATION | A001.jar |
| A002 | Print APPLICATION | A002.jar |

The application information table illustrated in Table 1 has an application ID column storing an application ID being an identifier by which the type of an application file can be uniquely identified. An application name column stores an application name. An application file path column stores a path in the hard disk 224 in the license server 101 storing the application file. The application information table has records each called an application information record and registered in units of application files. An application information record is added when an application information registration request receiving unit 321, which will be described below, receives an application information registration request.

A product information storage unit 312 is configured to store within the hard disk 224 in the license server 101 a product information table storing product information. The term “product” here refers to a unit for selling an application file, and a customer may purchase a unit of product information. Table 2 illustrates an example product information table stored in the product information storage unit 312.

TABLE 2

| PRODUCT | PRODUCT | APPLICATION | LICENSE ACCESS |
|---|---|---|---|
| ID | NAME | ID | NUMBER |
| P001 | PRODUCT A | A001 | LAN1 |
| P002 | PRODUCT B | A001, A002 | LAN2 |

The product information table in Table 2 has a product ID column storing a product ID being an identifier by which a product can be uniquely identified. Table 2 further has a product name column storing a product name. The application ID column stores an application ID of an application file to be available when the corresponding product is purchased. In a case where one product is licensed for a plurality of application files, a plurality of application IDs are set in the application ID column. Table 2 further has a license access number column storing a license access number for using the corresponding product by a customer. A license access number is used as a number for identifying a product for registering usage information, which will be described below. The product information table has records each called a product information record and registered in units of products. A product information record is added when a product information registration request receiving unit 322, which will be described below, receives product information registration request.

A usage information storage unit 313 is configured to store within the hard disk 224 in the license server 101 a usage information table storing usage information. The term “usage information” refers to information regarding a license between a customer and a distributor including information regarding which period the product is usable in the image forming apparatus purchased by a customer. Thus, usage information is also called license information, and the usage information storage unit 313 is also called a license information storage unit. Table 3 illustrates an example usage information table stored in the usage information storage unit 313.

TABLE 3

| LICENSE | APPARATUS | USAGE | USAGE | | | NEXT |
|---|---|---|---|---|---|---|
| ACCESS | SERIAL | STARTING | ENDING | CUTOFF | | ISSUING |
| NUMBER | NUMBER | DATE | DATE | DATE | STATUS | DATE |
| LAN1 | DSN1 | Jan. 1, 2016 | Mar. 31, 2016 | 20 | IN USE | Mar. 20, 2016 |
| LAN2 | DSN1 | Apr. 1, 2016 | — | 20 | BEFORE | Apr. 20, 2016 |
| | | | | | START OF | |
| | | | | | USE | |
| LAN2 | DSN2 | Mar. 1, 2016 | Mar. 31, 2016 | 20 | USE | Mar. 20, 2016 |
| | | | | | STOPPED | |

The usage information table in Table 3 has a license access number column storing a license access number of a product under license with a customer. Table 3 has an apparatus serial number column storing an apparatus serial number being a value by which the image forming apparatus under a license with a customer can be uniquely identified. Table 3 further has a usage starting date column storing a date of start of a licensed period for a licensed customer. Table 3 further has a license-ending-date column storing an ending date of a license for a licensed customer. In a case where the usage ending date is not determined, the usage ending date column stores “-”. Table 3 further has a cutoff date column storing a date of issuance of a license of every month. Table 3 further has a status column storing a status of usage information. Table 3 further has a date-of-next-issuance column storing date of next issuance of a license.

A record on the usage information table is called a usage information record and is added for each usage information registered by a usage information registration request receiving unit 323, which will be described below.

The example on Table 3 stores data indicating that an image forming apparatus having DSN1 as its apparatus serial number is licensed to use a LAN1 from Jan. 1, 2016 to Mar. 31, 2016 and is licensed to use a LAN2 from the next date, Apr. 1, 2016. The example further stores data indicating that an image forming apparatus having DSN2 as its apparatus serial number is licensed to use LAN 2 from Mar. 1, 2016 to Mar. 31, 2016.

A license information storage unit 314 is configured to store within the hard disk 224 in the license server 101 license information table holding information regarding an issued license. Table 4 illustrates an example license information table stored in the license information storage unit 314.

TABLE 4

| | APPARATUS | USAGE | USAGE | AUTHENTI- | | LICENSE | SERVICE | SERVICE |
|---|---|---|---|---|---|---|---|---|
| APPLICATION | SERIAL | STARTING | ENDING | CATION | LICENSE | MANAGEMENT | STARTING | ENDING |
| ID | NUMBER | DATE | DATE | DATE | PATH | STATUS | DATE | DATE |
| A001 | DSN1 | Feb. 20, 2016 | Mar. 31, 2016 | Mar. 20, 2016 | L001.lic | CONTINUE | Feb. 20, 2016 | Mar. 19, 2016 |
| | | | | | | INQUIRY | | |
| A001 | DSN1 | Mar. 20, 2016 | Apr. 30, 2016 | Apr. 20, 2016 | L002.lic | CONTINUE | Mar. 20, 2016 | Apr. 19, 2016 |
| | | | | | | INQUIRY | | |
| A002 | DSN1 | Apr. 1, 2016 | Apr. 30, 2016 | Apr. 20, 2016 | L003.lic | CONTINUE | Apr. 1, 2016 | Apr. 19, 2016 |
| | | | | | | INQUIRY | | |
| A001 | DSN2 | Mar. 1, 2016 | Mar. 31, 2016 | Mar. 20, 2016 | L004.lic | CONTINUE | Mar. 1, 2016 | Mar. 19, 2016 |
| | | | | | | INQUIRY | | |
| A001 | DSN2 | Mar. 20, 2016 | Mar. 31, 2016 | Mar. 31, 2016 | L005.lic | INQUIRY NOT | Mar. 20, 2016 | Mar. 31, 2016 |
| | | | | | | REQUIRED | | |
| A002 | DSN2 | Mar. 1, 2016 | Mar. 31, 2016 | Mar. 20, 2016 | L006.lic | CONTINUE | Mar. 1, 2016 | Mar. 19, 2016 |
| | | | | | | INQUIRY | | |
| A002 | DSN2 | Mar. 20, 2016 | Mar. 31, 2016 | Mar. 31, 2016 | L007.lic | INQUIRY NOT | Mar. 20, 2016 | Mar. 31, 2016 |
| | | | | | | REQUIRED | | |

The license information table on Table 4 has an application ID column storing an application ID of an application file to be usable under an issued license. Table 4 further has an apparatus serial number column storing an apparatus serial number of an image forming apparatus which is to be permitted to use an application file under an issued license. Table 4 further has a usage starting date column storing a date of start of a usable period for an application file under an issued license. Table 4 further has a license-ending-date column storing an ending date of a period in which an application file is usable under an issued license. Table 4 further has an authentication-date column storing a date when an image forming apparatus requests a license server to authenticate a license under the issued license. Table 4 further has a license path column storing a path on a file system storing an issued license. Table 4 further has a license management status column storing a status indicating whether an image forming apparatus is to request license authentication. Table 4 further has a license management status column storing one of two status of “CONTINUE INQUIRY” and “INQUIRY NOT REQUIRED”. Table 4 further has a service-starting-date column storing a starting date of a period for providing a license stored in a path in the issued license path column to the image forming apparatus. Table 4 further has a service-ending-date column storing an ending date of a period for providing a license stored in a path in the issued license path column to the image forming apparatus.

The license information table has records each of which is called a license information record and is added every time a license is issued by the usage information registration request receiving unit 323 and a license issuing unit 326, which will be described below.

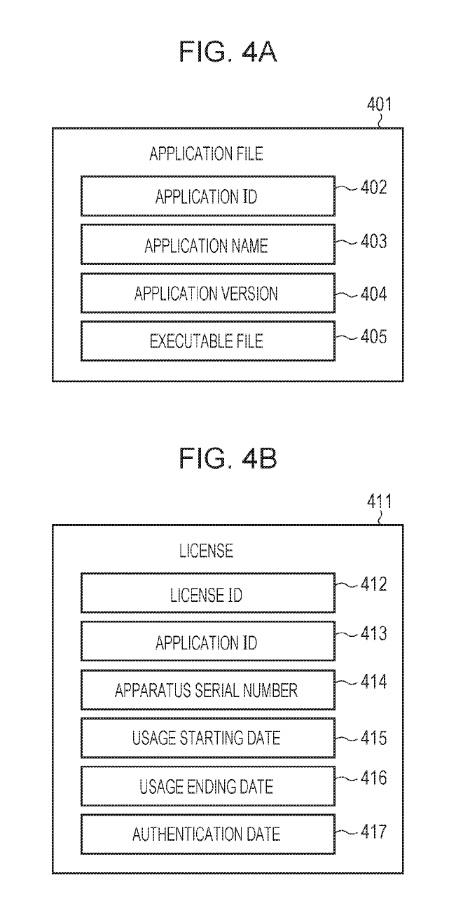

The application information registration request receiving unit 321 is configured to be executed in response to an application information registration request from a network I/F (network interface) 226 provided in the license server 101. An application information registration request is transmitted from the information processing apparatus 121 of a distributor. The application information registration request receiving unit 321 obtains an application file 401 illustrated in FIG. 4A from the received application information registration request and stores it in the hard disk 224. The application information registration request receiving unit 321 obtains an application ID 402 and an application name 403 in the stored application file 401. The path for the stored application file 401 and the obtained application ID 402 and application name 403 are added as new application information records to the application information table in Table 1.

The product information registration request receiving unit 322 is configured to be executed in response to a product information registration request from the Network I/F 226 provided in the license server 101. The product information registration request is transmitted from the information processing apparatus 121 of the distributor. The product information registration request contains at least a product ID, a product name, and an application ID. The product information registration request receiving unit 322 is configured to uniquely generate a license access number. The product information registration request receiving unit 322 adds the data obtained from the received product information registration request and the issued license access number as new product information records to the product information table on Table 2.

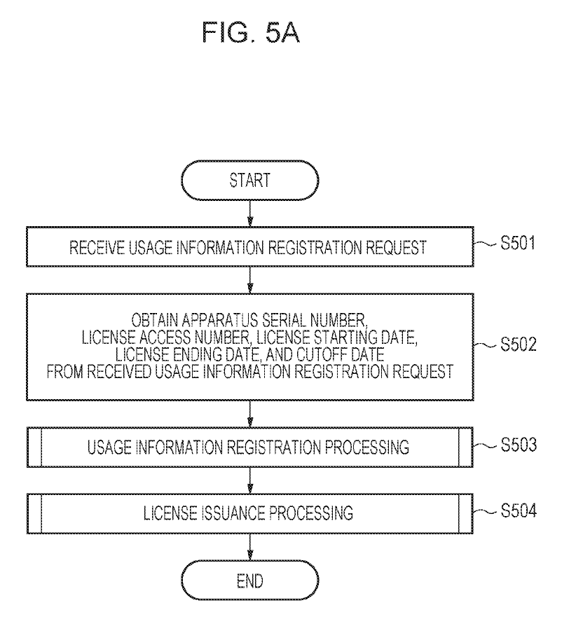

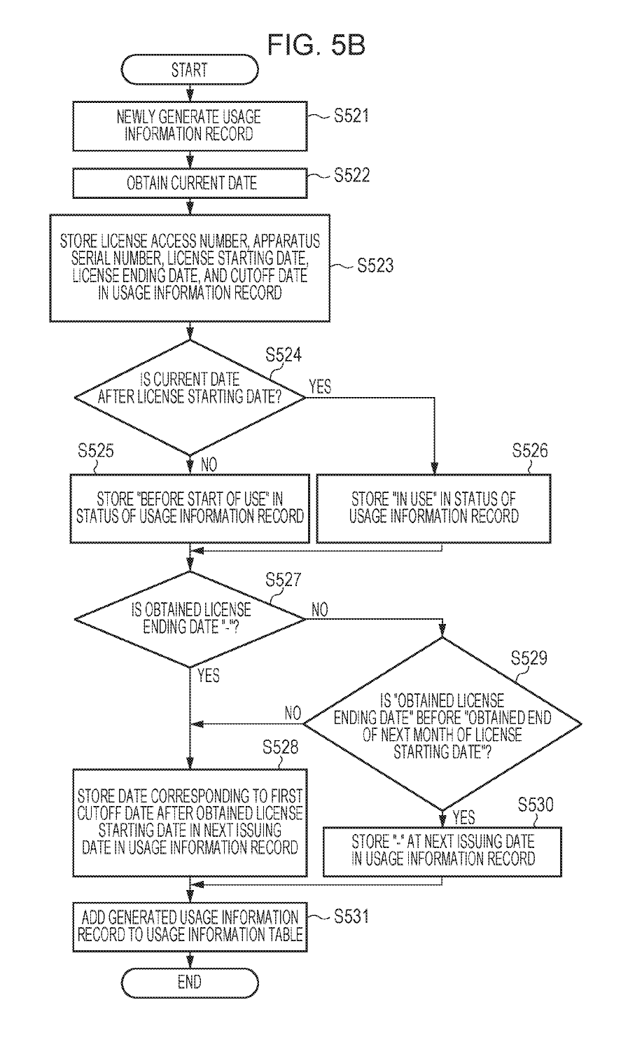

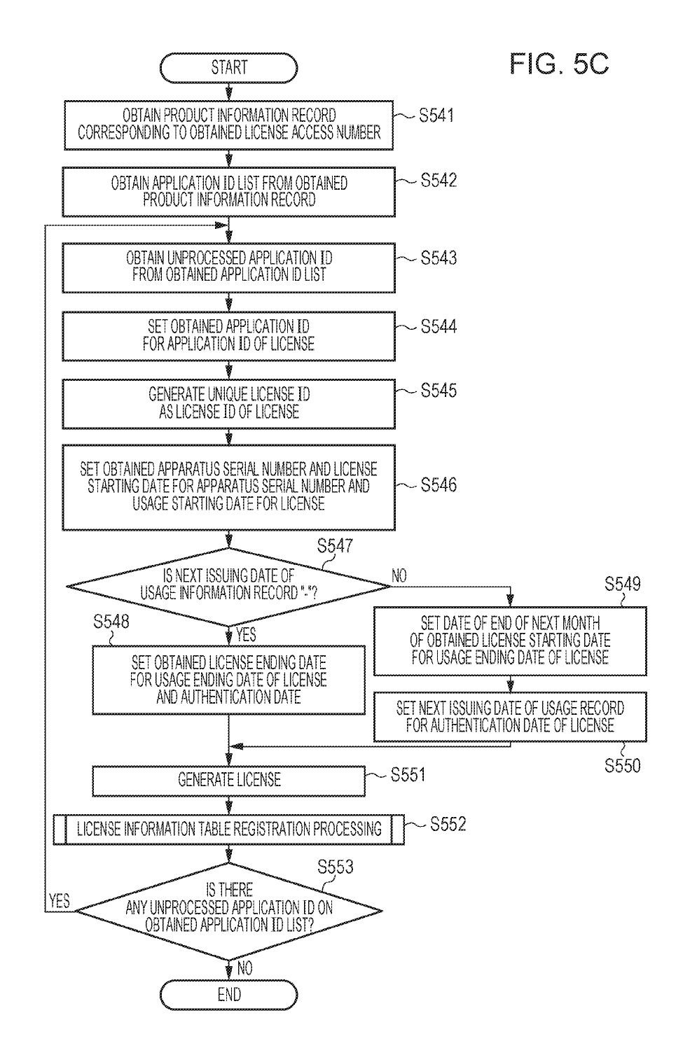

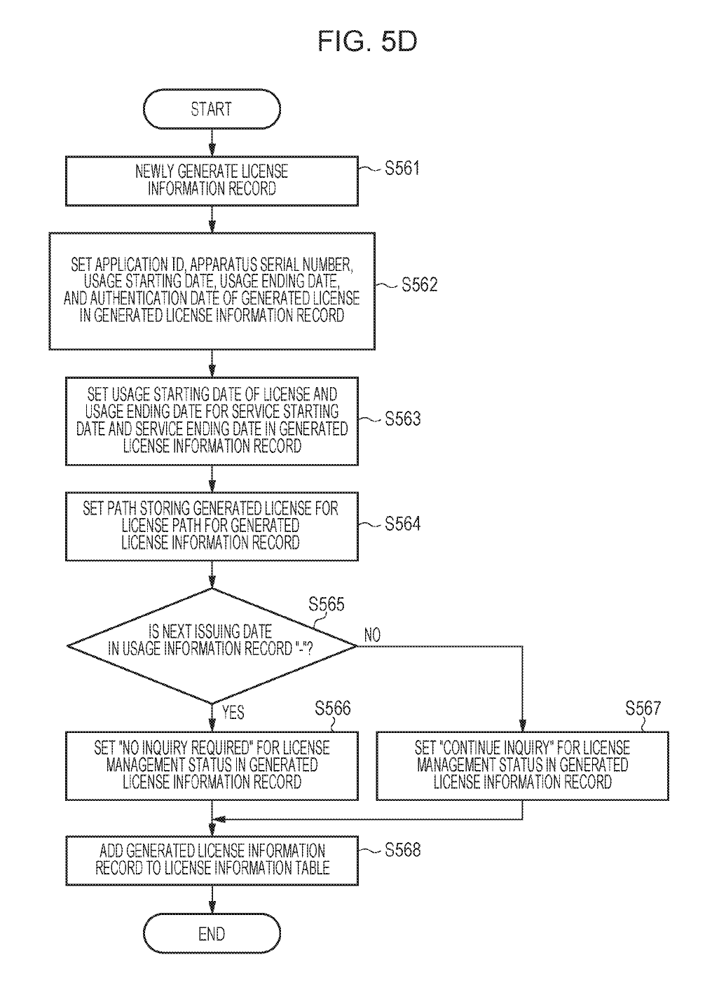

The usage information registration request receiving unit 323 is configured to be executed in response to a usage information registration request from the network I/F 226 provided in the license server 101. The usage information registration request is transmitted from the information processing apparatus 121 of a distributor or the license server 122. The usage information registration request contains at least a license access number, an apparatus serial number, a usage starting date, a usage ending date, and a cutoff date. The usage information registration request receiving unit 323 is configured to generate a usage information record based on the received usage information registration request and adds it to the usage information table on Table 3. In a case where the date for ending the license is undecided, the usage information registration request storing “-” as the usage ending date is to be transmitted. Processing to be executed by the usage information registration request receiving unit 323 will be described in detail with reference to a flowchart in FIGS. 5A to 5D.

An application file acquisition request receiving unit 324 is configured to be executed in response to an application file acquisition request from the network I/F 226 provided in the license server 101. The application file acquisition request contains a license access number. The application file acquisition request receiving unit 324 responds with an application file 401 associated with the license access number contained in the obtained application file acquisition request.

More specifically, the application file acquisition request receiving unit 324 obtains a license access number from the obtained application file acquisition request. Next, the application file acquisition request receiving unit 324 obtains a product information record matched with the obtained license access number from the product information table on Table 2. Next, the application file acquisition request receiving unit 324 obtains an application ID list from the obtained product information record. Next, the application file acquisition request receiving unit 324 obtains an application information record matched with the application ID on the obtained application ID list from the application information table on Table 1. The application file acquisition request receiving unit 324 responds with the application file 401 of the file path included in the obtained application information record.

A license acquisition request receiving unit 325 is configured to be executed in response to a license acquisition request from the network I/F 226 provided in the contains a license access number and an apparatus serial number. The license acquisition request receiving unit 325 responds with a license 411 corresponding to the obtained license access number and apparatus serial number. In other words, the license acquisition request receiving unit 325 may be a license transmitting unit.

More specifically, the license acquisition request receiving unit 325 obtains a product information record matched with the license access number contained in the received license acquisition request from a product information record on Table 2 and obtains an application ID list included in the product information record. Next, the license acquisition request receiving unit 325 obtains a license information record list including the obtained application ID list and an apparatus serial number included in the license acquisition request from the license information table on Table 4. If the license information record list is obtained, a license information record list having values of the service starting date and the service ending date satisfying “service starting date≤current date≤service ending date” in the license information record list is further searched and responds with the license 411 stored in the value satisfying the condition of the license path of the license information record list.

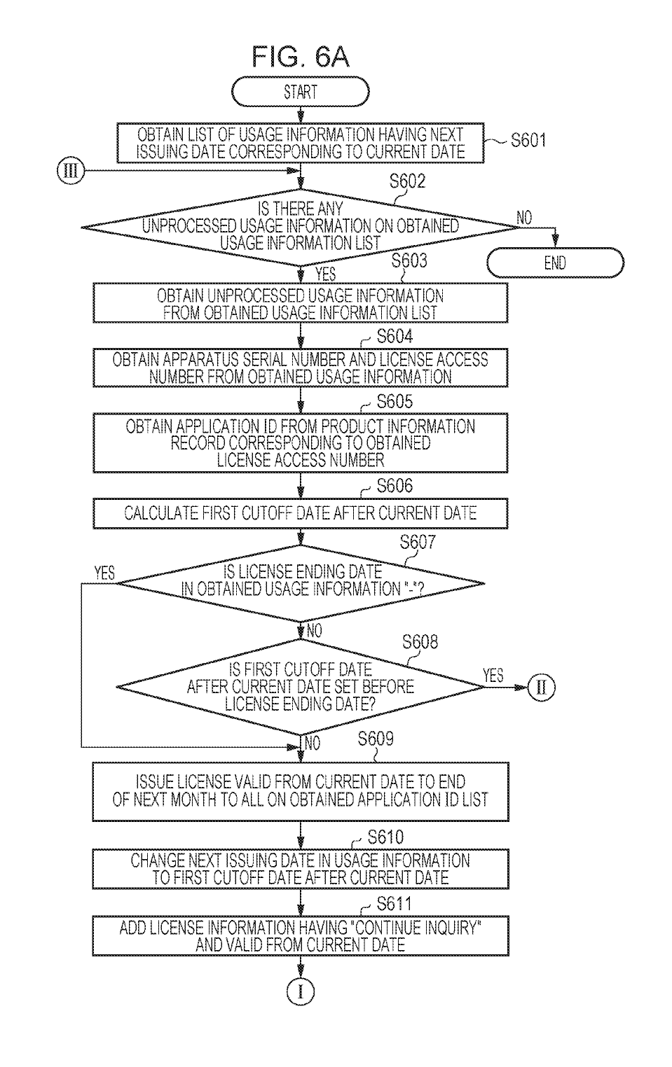

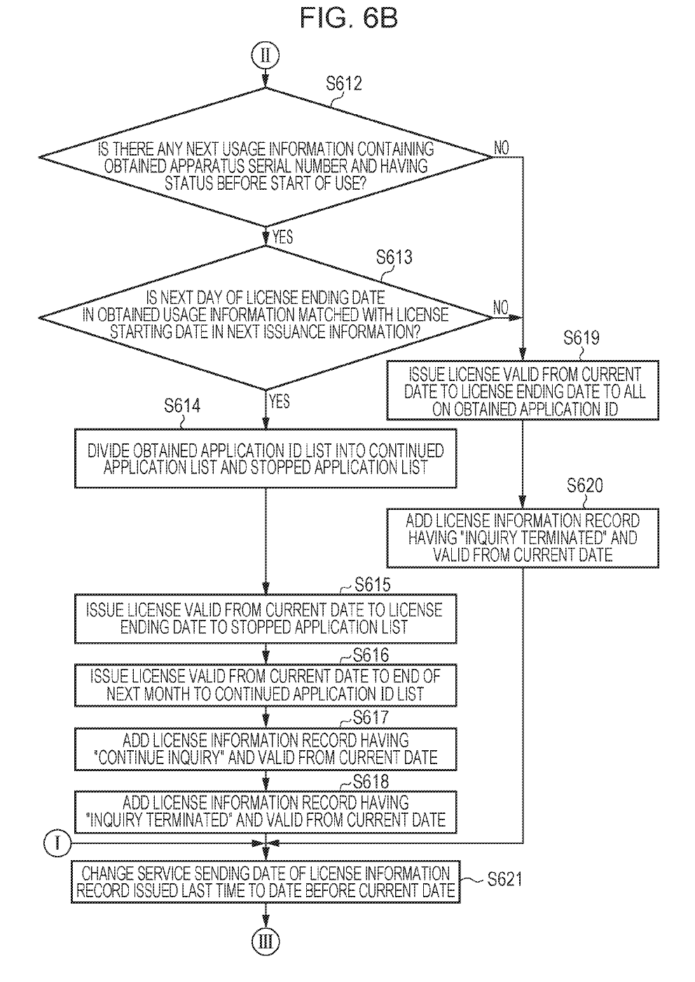

A license issuing unit 326 is configured to be periodically executed by the license server 101. The license issuing unit 326 issues the license 411 to a usage information record having “current date” equal to the value of the date-of-next-issuance column. Processing to be executed by the license issuing unit 326 will be described in detail with reference to the flowchart in FIGS. 6A and 6B.

A license authentication request receiving unit 327 is configured to be executed in response to a license authentication request from the network I/F 226 provided in the license server 101. The license authentication request contains an application ID list and an apparatus serial number. The license authentication request receiving unit 327 responds with the license 411 based on the obtained application ID list and apparatus serial number.

More specifically, the license authentication request receiving unit 327 obtains a license information record list including the obtained application ID list and apparatus serial number from the license information table on Table 4. If the license information record list is obtained, a license information record list having values of the service starting date and the service ending date satisfying “service starting date≤current date≤service ending date” in the license information record list is further searched and responds with the license 411 stored in the value satisfying the condition of the license path of the license information record list.

### Software in Image Forming Apparatus

Referring to FIG. 3B, the components of the software configuration 302 are configured to be executed by programs stored in the hard disk 208 and loaded to the volatile memory 210 by the CPU 207 in the image forming apparatus 112.

An apparatus information storage unit 341 is configured to hold an apparatus information table in the hard disk 208 in the image forming apparatus 112. The apparatus information table at least holds an apparatus serial number for uniquely identifying the image forming apparatus 112.

An apparatus license information storage unit 342 is configured to hold an apparatus license information table in the hard disk 208 in the image forming apparatus 112. Table 5 illustrates an apparatus license information table example stored in the apparatus license information storage unit 342.

TABLE 5

| | | USAGE | USAGE | | | |
|---|---|---|---|---|---|---|
| APPLICATION | APPLICATION | STARTING | ENDING | AUTHENTICATION | STORAGE | INQUIRY |
| ID | NAME | DATE | DATE | DATE | PATH | FLAG |
| A001 | Scan | Mar. 21, 2016 | Apr. 30, 2016 | Apr. 20, 2016 | /apps/scan/jar | TRUE |
| | APPLICATION | | | | | |
| A002 | Print | Apr. 1, 2016 | Apr. 30, 2016 | Apr. 20, 2016 | /apps/print.jar | TRUE |
| | APPLICATION | | | | | |

Referring to Table 5, the apparatus license information table has an application ID column storing an application ID of an installed application file 401. Table 5 has an application name column stores an application name of the application file. Table 5 has a usage starting date column storing a usage starting date of the application file. A license-ending-date column stores a usage ending date of the application file. A license authentication date column stores a license updating date. Table 5 has a storage path column storing a path for the hard disk 208 in the image forming apparatus 112 storing the application file. Table 5 has an inquiry flag column storing information regarding whether the license server 101 is to be requested to automatically authenticate the license.

The image forming apparatus 112 determines whether the application file 401 is licensed or not based on the information stored in the apparatus license information table. In a case where the usage starting date and usage ending date columns have values and if a relationship of “usage starting date≤current date≤usage ending date” is satisfied, it is determined that the application file 401 is licensed.

The apparatus license information table has records each of which is called an apparatus license information record, and an apparatus license information record is added every time the application file 401 is installed under the license 411.

An install request receiving unit 351 is configured to be executed in response to an install request from the network I/F 205 in the image forming apparatus. The install request is transmitted from the information processing apparatus 111. The install request contains a license access number. The install request receiving unit 351 transmits an application file acquisition request including the license access number included in the received install request and the apparatus serial number held in the apparatus information storage unit 341 and the license acquisition request to the license server 101. The install request receiving unit 351 performs determination processing regarding whether to install the application file by using the application file 401 and the license 411 responded to the transmitted application file acquisition request and the license acquisition request.

The install request receiving unit 351 determines that the application can be installed if the following tow conditions are satisfied. A first condition is that the application ID included in the obtained license is matched with the application ID of the application file. A second condition is that the obtained apparatus serial number of the license is matched with the apparatus serial number held in the apparatus information storage unit 341. If the two conditions are satisfied, the install request receiving unit 351 determines that the application file can be installed and adds an apparatus license information record based on the obtained information regarding the application file and the license. The apparatus license information record to be added has an inquiry flag set to TRUE.

A license authentication request transmitting unit 352 is configured to transmit the license authentication request to the license server 101. The license authentication request transmitting unit 352 is configured to be executed if the inquiry flag of the apparatus license information record on Table 5 included in the apparatus license information table has TRUE and if the license authentication date is after the current date.

When the license authentication request transmitting unit 352 is executed to obtain an application ID list from an apparatus license information record list having an inquiry flag at TRUE and the license authentication date after the current date in the apparatus license information table in Table 5. The license authentication request transmitting unit 352 further obtains the apparatus serial number stored in the apparatus information storage unit 341. The license authentication request transmitting unit 352 further transmits a license authentication request including the obtained application ID list and the apparatus serial number. The license authentication request transmitting unit obtains the responded license 411 and updates the usage starting date, the usage ending date, the license authentication date in the apparatus license information record by using the license. If the license management status is the responded “NO INQUIRY REQUIRED”, the inquiry flag is set to FALSE. If the license management status is “CONTINUE INQUIRY”, the inquiry flag is set to TRUE.

### Application File and License File

FIGS. 4A and 4B illustrate data structures of files. FIG. 4A and FIG. 4B illustrate data structures of the application file 401 and the license 411, respectively.

The application file 401 illustrated in FIG. 4A is an extended program file to be installed for using a basic function and using an extended function afterwards. The application file 401 holds at least information pieces 402 to 405. An application ID 402 is an identifier by which a category of the application file 401 can be uniquely identified. An application name 403 and an application version 404 are a name and a version of the application file 401. An executable file 405 is a program for operating in the image forming apparatus 112.

The license 411 illustrated in FIG. 4B is issued by the usage information registration request receiving unit 323 and the license issuing unit 326. The license 411 holds at least information pieces 412 to 417. A license ID 412 is an identifier by which a license can be uniquely identified. An application ID 413 is an identifier of an application file 401 which can be installed under the license. An apparatus serial number 414 is a serial number of the image forming apparatus 112 in which the application file can be installed under the license. A usage starting date 415 and a usage ending date 416 are a date for starting usage of the application file 401 and a date for ending the usage under the license, respectively.

An authentication date 417 is a date when the image forming apparatus 112 in which the application file is installed under the license requests the license server to authenticate the license.

License Issuing Processing by Usage information Registration Request Receiving Unit

A first embodiment of the present invention will be described with reference to flowcharts in FIGS. 5A to 5D. FIG. 5A is a flowchart illustrating processing to be executed in response to a usage information registration request received by the usage information registration request receiving unit 323 in the license server 101 through the network I/F 226. The usage information registration request is transmitted from the information processing apparatus 121 in the distributor network environment 120. The usage information registration request receiving unit 323 registers usage information and issues a license 411 based on a license access number, an apparatus serial number, a usage starting date, a usage ending date, and a cutoff date included in the received usage information registration request.

In step S501, the usage information registration request receiving unit 323 receives a usage information registration request.

In step S502, the usage information registration request receiving unit 323 obtains an apparatus serial number, a license access number, a usage starting date, a usage ending date, and a cutoff date from the usage information registration request obtained in S501. If the date for ending the license is not undecided, the usage ending date has “-”.

In step S503, the usage information registration request receiving unit 323 performs usage information registration processing. The usage information registration processing will be described with reference to flowchart in FIG. 5B.

In step S504, the usage information registration request receiving unit 323 performs license issuing processing. The license issuing processing will be described with reference to the flowchart in FIG. 5C.

### Usage Information Registration Processing

FIG. 5B is a flowchart illustrating usage information registration processing to be executed in step S503. The usage information registration processing includes processing for registering a usage information record with the usage information table on Table 3 based on the usage information registration request received in S501 and the current date.

In step S521, the usage information registration request receiving unit 323 newly generates a usage information record. In step S522, the usage information registration request receiving unit 323 obtains the current date. In step S523, the usage information registration request receiving unit 323 stores the license access number, apparatus serial number, usage starting date, usage ending date, and cutoff date obtained in S502 in the usage information record generated in S521. In step S524, the usage information registration request receiving unit 323 determines whether the current date obtained in S522 is on or after the usage starting date obtained in S502. If the current date is before the usage starting date, it is determined that it is before the licensed period. The processing then moves to S525. If the current date is on or after the usage starting date, it is determined that it is in the middle of the licensed period. The processing then moves to S526.

In step S525, the usage information registration request receiving unit 323 sets “BEFORE START OF USE” as a status of the usage information record generated in S521. In step S526, the usage information registration request receiving unit 323 sets “IN USE” as a status of the usage information record generated in S521.

In step S527, the usage information registration request receiving unit 323 determines whether the usage ending date obtained in S502 is “-” or not. If the usage ending date is “-”, the processing moves to S528. If not, the processing moves to S529. If the usage ending date is “-”, the date for ending the license is undecided.

In step S528, the usage information registration request receiving unit 323 sets a date corresponding to the cutoff date on or after the usage starting date (usage starting date in FIG. 5B) obtained in S502 as the next issuing date in the usage information record generated in S521. For example, if the usage starting date is “Apr. 1, 2016” and if the cutoff date is “20”, the next issuing date is “Apr. 20, 2016”. As another example, if the usage starting date is “Apr. 28, 2016” and if the cutoff date is “20”, a next issuing date “May 20, 2016” is to be stored.

In step S529, the usage information registration request receiving unit 323 determines whether the “usage ending date obtained in S502” is before the “end of the next month of the usage starting date obtained in S502”. If these conditions are satisfied, the processing moves to S530. If not, the processing moves to S528. In step S530, the usage information registration request receiving unit 323 stores “-” as the next issuing date in the usage information record generated in S521. The determination in step S529 may include determination on whether the licensed period is equal to one month or two or more months, assuming that the start of the licensed period is the first day or the last day of a month. In other words, assuming as described above, if the licensed period is two or more months, a next issuing date may be set. If the license period is one month, a next issuing date may not be set. Thus, a licensed period may be divided into predetermined periods (month in this example), and a license may be issued for each period.

In step S531, the usage information registration request receiving unit 323 adds the usage information record generated in S521 to the usage information table on Table 3. A usage information record is newly generated and is added through the procedure as described above.

A usage information record is generated and is registered with a usage information table through the procedure as described above. In the processing, the next issuing date of a license is determined as being undecided if the obtained usage ending date is before the end of the next month of the usage starting date. This is because the usage ending date of a license is set as the end of the next month of the usage starting date, as described with reference to step S549 in FIG. 5C. In other words, in a case where a license expires without updating the license every month, the next issuing date of the license is determined as being undecided. On the other hand, if the obtained usage ending date is “undecided” or if the obtained usage ending date is after the end of the next month of the usage starting date, the earliest cutoff date on or after the usage starting date is set as the next issuing date of the license. In other words, in a case where a license needs to be updated every month, the first cutoff date after the usage starting date is set as the next issuing date of the license.

### License Issuing Processing

FIG. 5C is a flowchart illustrating license issuing processing to be executed in step S504. The license issuing processing includes processing for issuing the license 411 based on the received usage information registration request and registering information regarding the issued license with the license information table on Table 4.

In step S541, the usage information registration request receiving unit 323 obtains a product information record matched with the license access number obtained in S502 from the product information table on Table 2. In step S542, the usage information registration request receiving unit 323 obtains an application ID list from the application ID column in the product information record obtained in S541. In step S543, the usage information registration request receiving unit 323 obtains an unprocessed application ID from the application ID list obtained in S542. In step S544, the usage information registration request receiving unit 323 sets the application ID obtained in S543 as the application ID 413 of the license 411. In step S545, the usage information registration request receiving unit 323 generates a license ID by which a license can uniquely be identified and sets it as the license ID 412 of the license 411. In step S546, the usage information registration request receiving unit 323 sets the apparatus serial number and the usage starting date obtained in S502 as the apparatus serial number 414 and usage starting date 415 of the license 411. In step S547, the usage information registration request receiving unit 323 determines whether the next issuing date in the usage information record registered in S531 is “-” or not. If the next issuing date is “-”, that is, if the next issuing date is undecided, the processing moves to step S548. If the next issuing date is not “-”, the processing moves to step S549.

In step S548, the usage information registration request receiving unit 323 sets the usage ending date obtained in S502 as the usage ending date 416 and the authentication date 417 of the license 411.

In step S549, the usage information registration request receiving unit 323 sets the date of the end of the next month of the usage starting date obtained in S502 as the usage ending date 416 of the license 411. In step S550, the usage information registration request receiving unit 323 sets the next issuing date in the usage information record registered in S531 as the authentication date 417 of the license 411.

In step S551, the usage information registration request receiving unit 323 generates a license holding the information of the license set in S544 to S550. The generated license is stored in the hard disk 224 in the license server 101. In step S552, license information registration processing is performed for registering the information regarding the license generated in S551 with the license information table on Table 4. The license information registration processing will be described in detail with reference to FIG. 5D. In step S553, the usage information registration request receiving unit 323 checks whether the application ID list obtained in S542 has any unprocessed application ID or not. If the application ID list has an unprocessed application ID, the processing moves to S543. If not, the processing ends.

Through the procedure as described above, a license is generated and is registered with the license information table. Here, if the next issuing date of the license is undecided, that is, if the licensed period will expire without updating the license, the usage ending date is set as the usage ending date and authentication date of the license in step S548. On the other hand, if the next issuing date of the license is decided, that is, if the license update is required every month, the end of the next month of the usage starting date is set as the usage ending date of the license in step S549. Further in that case, the next issuing date of a usage information record is set as an authentication date of the license in step S550. In a case where a license update is necessary every month as described above, the cutoff date immediately preceding expiration of the usage period of the license is set as a date for authenticating the license.

### License Information Registration Processing

FIG. 5D is a flowchart illustrating license information registration processing to be executed in step S552. The license information registration processing includes processing for registering information regarding an issued license 411 as a license information record with the information table on Table 4.

In step S561, the usage information registration request receiving unit 323 newly generates a license information record. In step S562, the usage information registration request receiving unit 323 stores the application ID, apparatus serial number, usage starting date, usage ending date, and authentication date of the license generated in S551 in the license information record generated in S561. In step S563, the usage information registration request receiving unit 323 stores the usage starting date and usage ending date of the license generated in S551 in a service starting date and a service ending date in the license information record generated in S561. In step S564, the usage information registration request receiving unit 323 stores the path to the hard disk 224 in license server 101 storing the license generated in S551 as a license path to the license information record generate in S551.

In step S565, the usage information registration request receiving unit 323 determines whether the next issuing date in the usage information record registered in S531 is “-” or not. If the next issuing date is “-”, the processing moves to step S566. If the next issuing date is not “-”, the processing moves to step S567.

In step S566, the usage information registration request receiving unit 323 stores “NO INQUIRY REQUIRED” as a license management status in the license information record generated in S561.

In step S567, the usage information registration request receiving unit 323 stores “CONTINUE INQUIRY” as a license management status in the license information record generated in S561.

In step S568, the usage information registration request receiving unit 323 adds the license information record generated in S561 to the information table on Table 4.

Through the procedure as described above, the license information record is newly registered. Here, if the next issuing date is undecided, it is set that no inquiry is necessary. If it is decided, it is set to continue the inquiry.

### License Issuing Processing by License Issuing Unit

FIGS. 6A and 6B are flowcharts illustrating processing to be executed by the license issuing unit 326 in the license server 101. FIGS. 6A and 6B illustrates a procedure of a batch program to be executed periodically such as every day, and the license issuing unit 326 executes the batch program periodically such as at a predetermined clock time every day. This is because a license is to be managed in units of days, and the intervals of the execution may be determined based on the units for the license management. For example, in a case where a license is managed in units of months, the program illustrated in FIGS. 6A and 6B may be executed of a predetermined day of every month.

When the license issuing unit 326 is executed, a license 411 of usage information is issued which has the current date as the next issuing date.

In step S601, the license issuing unit 326 obtains a usage information record list having the current date as the next issuing date from the usage information table on Table 3.

In step S602, the license issuing unit 326 checks whether the usage information record list obtained in S601 has any unprocessed usage information record or not. If so, the processing moves to S603. If not, the processing ends.

In step S603, the license issuing unit 326 obtains an unprocessed usage information record from the usage information record list obtained in S601. Such a usage information record will be called a usage information record of interest or a usage information record to be processed.

In step S604, the license issuing unit 326 obtains an apparatus serial number and a license access number from the usage information record obtained in S603. In step S605, the license issuing unit 326 obtains a product record matched with the license access number obtained in S604 from the product information table on Table 2. An application ID list stored in the application ID column of the obtained product information record is then obtained. In step S606, the license issuing unit 326 calculates the first cutoff date after the current date. In a case where current date is the next issuing date, the cutoff date is set as the next issuing date (referring to S528), the first cutoff date after the current date is a “date after one month from the current date”. For example, in a case where the current date is Mar. 20, 2016, the first cutoff date after the current date is Apr. 20, 2016. In step S607, the license issuing unit 326 determines whether the usage ending date of the usage information record of interest obtained in S603 is “-”. If so, that is, if the usage ending date is undecided, the processing moves to S609. If it is not “-”, the processing moves to S608.

In step S608, the license issuing unit 326 determines whether the first cutoff date after the current date calculated in S606 is before the usage ending date of the usage information record of interest obtained in S603. If the first cutoff date after the current date is before the usage ending date of the usage information record of interest obtained in S603, it is determined that the license in the usage information record of interest obtained in S603 still continues, and the processing moves to S609. If the first cutoff date after the current date is on or after the usage ending date of the usage information record of interest obtained in S603, it is determined that the license in the usage information record of interest obtained in S603 ends, and the processing moves to S612.

If it is determined that the license still continues, the license issuing unit 326 in step S609 issues the license 411 to each IDs on the application ID list obtained in S605. Details of the issued license 411 store the current date as the usage starting date 415, the date of the end of the next month as the usage ending date 416, and the first cutoff date after the current date calculated in S606 as the authentication date 417. The license ID 412 stores a license ID that is uniquely generated, the application ID 413 stores the application obtained in ID S605, and the apparatus serial number 414 stores the apparatus serial number obtained in S604. The issued license 411 is stored in the hard disk 224 of the license server 101.

In step S610, the license issuing unit 326 updates the next issuing date of the usage information record of interest obtained in S603 by setting the first cutoff date after the current date calculated in S606. In step S611, the license issuing unit 326 stores information regarding a list of the licenses issued in S609 in the license information record. License information records are generated the number of which is equal to the number of the application IDs obtained in S605. Each of the license information records to be generated stores the application ID 413 of the license 411 issued in S609, the apparatus serial number 414, the usage starting date 415, the usage ending date 416, and the authentication date 417. A column for a license path to a license information record stores a path on the hard disk 224 in the license server 101 storing the license 411 issued in S609. A column for a license management status in the license information record stores “CONTINUE INQUIRY”, and columns for a service starting date and a service ending date store the usage starting date 415 and the usage ending date 416, respectively, of the license 411.

On the other hand, if it is determined in step S608 that the license ends, the license issuing unit 326 in step S612 checks whether a usage information record exists which includes the apparatus serial number of the usage information record of interest obtained in S604 and has a status “BEFORE START OF USE”. If so, the processing moves to S613. If not, the processing moves to S619. A usage information record having a status “BEFORE START OF USE” will be called “next usage information record”.

In step S613, the license issuing unit 326 determines whether the next date of the usage ending date of the usage information record of interest obtained in S603 is the usage starting date of the next usage information record determined as existing in S612. In other words, the existence of a next usage information record having continuous licensed periods is determined, and the next usage information record is a usage information record set based on usage information different from usage information regarding the licenses issued in the past. If the conditions are satisfied, the processing moves to S614. If not, the processing moves to S619. Having described that, according to this embodiment, whether the next date of the usage ending date of the usage information record of interest obtained in S603 is the usage starting date of the next usage information record determined as existing in S612, whether the usage starting date is within a certain number of days may be determined instead of the next date. In other words, if a gap period between licenses is within a predetermined period, it may be determined that the licenses are issued continuously.

If it is determined in step S613 that a next usage information record having continuous licensed periods exists, the license issuing unit 326 in step S614 classifies the application ID list obtained in S605 as a “continued application ID list” including application IDs of applications to be used continuously or as “stopped application ID list” including application IDs the use of which is to be stopped. More specifically, whether the application ID list obtained in S605 includes an application ID matched with the application ID usable in the next usage information record determined as existing in S612 is checked. This check may include, for example, comparing the license access number of the corresponding next usage information record with the license access number on the product information table and matching the application ID of the corresponding record and the ID included in the application list. In the application ID list, a list of application IDs determined as being matched as a result of the check is a continued application ID list relating to the usage information record of interest. In the application ID list, a list of application IDs determined as not being matched is a stopped application ID list relating to the usage information record of interest.

In step S615, the license issuing unit 326 issues the license 411 which is usable from the current date to the usage ending date of the usage information record obtained in S603 to applications included in the stopped application ID list discriminated in S614. Details of the license 411 to be issued store the current date as the usage starting date 415, the usage ending date 416, and the usage ending date of the usage information record obtained in S603 as the authentication date 417. The license ID 412 stores a uniquely generated license ID, the application ID 413 stores the application ID obtained in S605, and the apparatus serial number 414 stores the apparatus serial number obtained in S604. The issued license 411 is stored in the hard disk 224 in the license server 101.

In step S616, the license issuing unit 326 issues the license 411 which can be used from the current date to the end of the next month to applications included in the continued application ID list discriminated in S614. Details of the license 411 to be issued store the current date as the usage starting date 415 and the end of the next month as the usage ending date 416. The authentication date 417 stores a calculated cutoff date of the next usage information record obtained in S612 on or after the current date. The license ID 412 stores a uniquely generated license ID, the application ID 413 stores the application ID obtained in S605, and the apparatus serial number 414 stores the apparatus serial number obtained in S604. The issued license 411 is stored in the hard disk 224 in the license server 101.

In step S617, the license issuing unit 326 stores, in the license information record, information regarding the license list issued to the continued application ID list in S616. This storing may be adding or changing (overwriting). License information records are generated the number of which is equal to the number of applications included in the continue application ID list discriminated in S614. The generated license information record stores the application ID 413 of the license 411 issued in S616, the apparatus serial number 414, the usage starting date 415, the usage ending date 416, and the authentication date 417. A column for a license path to a license information record stores a path on the hard disk 224 in the license server 101 storing the license 411 issued in S616. A column for a license management status in the license information record stores “CONTINUE INQUIRY”, and columns for a service starting date and a service ending date store the usage starting date 415 and the usage ending date 416, respectively, of the license 411.

In step S618, the license issuing unit 326 stores, in the license information record, information regarding the license list issued to the stopped application ID list in S615. License information records are generated the number of which is equal to the number of applications included in the stopped application ID list discriminated in S614. The generated license information record stores the application ID 413 of the license 411 issued in S615, the apparatus serial number 414, the usage starting date 415, the usage ending date 416, and the authentication date 417. A column for a license path to a license information record stores a path on the hard disk 224 in the license server 101 storing the license 411 issued in S615. A column for a license management status in the license information record stores “NO INQUIRY REQUIRED”, and columns for a service starting date and a service ending date store the usage starting date 415 and the usage ending date 416, respectively, of the license 411.

In step S619, the license issuing unit 326 issues the license 411 to each IDs on the application ID list obtained in S605. Details of the issued license 411 store the current date as the usage starting date 415 and the usage ending date of the usage information record obtained in S603 as the usage ending date 416 and the authentication date 417. The license ID 412 stores a license ID that is uniquely generated, the application ID 413 stores the application obtained in ID S605, and the apparatus serial number 414 stores the apparatus serial number obtained in S604. The issued license 411 is stored in the hard disk 224 of the license server 101.

In step S620, the license issuing unit 326 stores, in the license information record, information regarding the list of licenses issued in S619. License information records are generated the number of which is equal to the number of the application IDs obtained in S605. Each of the license information records to be generated stores the application ID 413 of the license 411 generated in S619, the apparatus serial number 414, the usage starting date 415, the usage ending date 416, and the usage ending date 417. A column for a license path to a license information record stores a path on the hard disk 224 in the license server 101 storing the license 411 issued in S619. A column for a license management status in the license information record stores “NO INQUIRY REQUIRED”, and columns for a service starting date and a service ending date store the usage starting date 415 and the usage ending date 416, respectively, of the license 411.

In step S621, the license issuing unit 326 performs processing for changing the service ending date of the license information record for the license 411 issued last time to a date before the current date. More specifically, a license information record including the application ID obtained in S605 and the apparatus serial number obtained in S604 and having the current date as an authentication date is obtained from the information table on Table 4. The date of the day before is stored as the service ending date of the obtained license information record for update. This can exclude overlapped licensed periods.

In a case where a second license for an application under a first license that is issued is to be issued based on license information including a licensed period continuous to the licensed period of the first license by performing the processing as described above, a usage period may be set such that the ending time of the first license can be continuous to the starting time of the second license to issue the second license.

### Processing for Registering Application and Apparatus License Information by Image Forming Apparatus

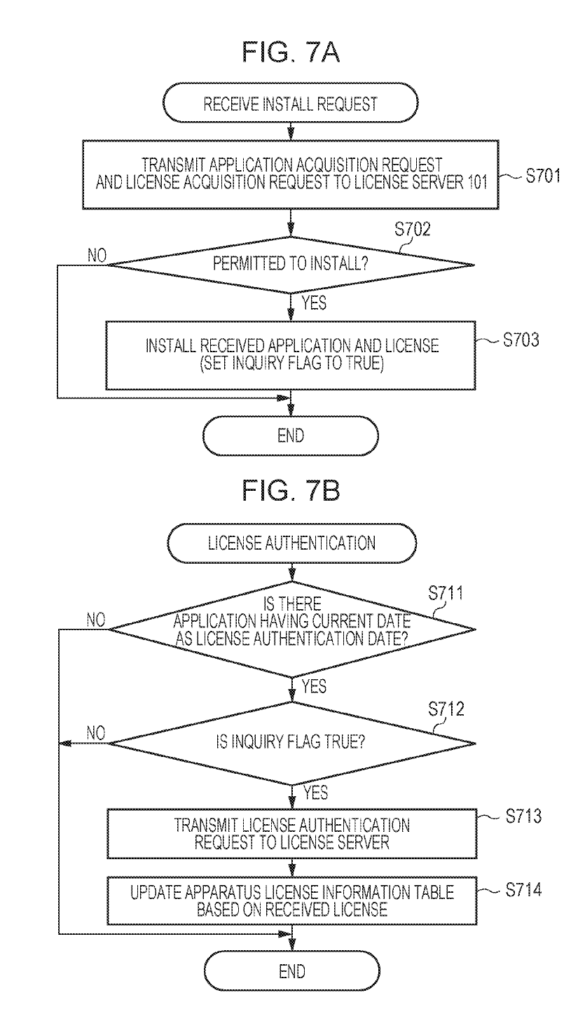

FIG. 7A Illustrates a procedure for registering an apparatus license to be performed by the image forming apparatus 112. The flowchart in FIG. 7A is started with a receipt by the image forming apparatus 112 of an install request including a license access number from the information processing apparatus 111. The install request is transmitted after license information (usage information) for the application is generated by the procedures in FIGS. 5A to 5D and is registered with the usage information table and a license is issued.

The install request receiving unit 351 in the image forming apparatus 112 transmits to the license server 101 the application file acquisition request including the license access number included in the received install request and the apparatus serial number held in the apparatus information storage unit 341 and a license acquisition request (S701). The install request receiving unit 351 receives the application file 401 and the license 411 returned in response to the transmitted application file acquisition request and license acquisition request. The application file 401 and the license 411 are used to perform processing for determining whether the application file is to be installed (step S702). This processing is performed in the manner as already described above. If the application ID included in the obtained license is matched with the application ID of the application file and if the apparatus serial number of the obtained license and the apparatus serial number held in the apparatus information storage unit 341 are matched, the application is installed based on the received application file. A record is added to the apparatus license information table based on the received application file and license (step S703). In this case, the inquiry flag for the apparatus license information record to be added is set to TRUE. As a storage path, a path is set which indicates a storage location of an executable file of the application. As an application name, an application name included in the installed application file is set. The other items may be copied from the items included in the received license 411. In a case where the application ID of the license to be installed newly is already exists, the existing license is overwritten for installing the application. Thus, for example, one record exists on the apparatus license information table on Table for one application ID.

### Processing for Updating Apparatus License Information by Image Forming Apparatus

FIG. 7B illustrates a procedure of a program to be executed periodically such as at a predetermined clock time every day by the license authentication request transmitting unit 352 in the image forming apparatus 112. The license authentication request transmitting unit 352 determines whether the apparatus license information table (Table 5) has an application, that is, an apparatus license information record having the current date as a license authentication date (or authentication time) (step S711). This assumes that the procedure in FIG. 7A is to be performed every day. In a case where the procedure is not performed every day, whether the current date is on or after the license authentication date or not may be determined. If there is an applicable record, whether the inquiry flag of the apparatus license information record is True is determined (step S712). If it is True, the application ID of the record is obtained, and an apparatus serial number stored in the apparatus information storage unit 341 is obtained. Then, a license authentication request containing these information pieces is transmitted (step S713). The license 411 returned in response to the license authentication request is received, and the license is used to update the usage starting date, the usage ending date, and the license authentication date in the apparatus license information record. If the license management status returned as a response is “NO INQUIRY REQUIRED”, the inquiry flag is set to FALSE. If the license management status is “CONTINUE INQUIRY”, the inquiry flag is set to TRUE (step S714).

Through the processing as described above, the image forming apparatus 112 can update the license. However, when a license authentication request is transmitted to the license server 101 in the procedure in FIG. 7B, the license server 101 transmits the license corresponding to the license authentication request if it is generated in the procedure in FIGS. 6A and 6B at that time but cannot transmit if it is not generated. Therefore, if the image forming apparatus 112 does not receive the license, the image forming apparatus 112 may periodically repeat transmitting the license authentication request. Alternatively, it may be scheduled such that the procedure in FIGS. 6A and 6B can be executed before the procedure in FIGS. 7A and 7B though the processing with respect to the same date is to be performed as the date to be handled in FIG. 7B. Alternatively, timing for transmitting a license authentication request by the image forming apparatus 112 may be adjusted such that a required license can be generated before the request such as the next date of the license authentication date.

In a case where next usage information which can be used continuously to the currently valid usage information is available and where an application having an identical application ID in the currently valid usage information and the next usage information is to be licensed, the license can be issue as being usable continuously, as described according to the embodiments. In other words, for an application with a continuous licensed period between an old license and a new license, a gap period of the license does not occur at a break in the licensed period. The convenience can be provided for an identical application in different products to be licensed by an old license and a new license.

Under the conditions, “CONTINUE INQUIRY” may be set as a license management status so that automatic transmission of a license authentication request from the image forming apparatus can be designated.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (D), digital versatile disc (DVD), or Blu-ray Disc (3D)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-237831 filed Dec. 7, 2016, which is hereby incorporated by reference herein in its entirety.

What is claimed is:

1. A license management system for managing a license for an application to be executed by an image forming apparatus, the system comprising;
a license information storage unit configured to store license information including a licensed period for permitting to use the application; and
a license issuing unit configured to issue a license for the application having a usage period set based on the license information,
wherein, in a case where a second license for an application corresponding to a first license that is issued based on license information is to be issued based on different license information including a licensed period continuous to the licensed period of the first license, the license issuing unit sets a usage period such that the ending time of the first license can be continuous to the starting time of the second license to issue the second license.

2. The license management system according to claim 1, further comprising:
a license transmitting unit configured to return the issued license in response to a license authentication request relating to the application from the image forming apparatus,
wherein the image forming apparatus transmits the license authentication request for an application in a period for authenticating its license, and the application is set to be authenticated; and
wherein the license issuing unit sets for the second license such that the image forming apparatus can perform the authentication.

3. The license management system according to claim 2, wherein the license issuing unit determines an ending time of the licensed period as an ending time of the usage period in a case where the licensed period is shorter than a predetermined length and sets such that the image forming apparatus does not perform the authentication.

4. The license management system according to claim 2, wherein the image forming apparatus receives the second license transmitted by the license transmitting unit in response to the license authentication request and writes and installs the second license over the first license.

5. The license management system according to claim 2, wherein the image forming apparatus periodically checks an installed license and transmits the license authentication request for an application in the authentication time, the application set to be authenticated.

6. The license management system according to claim 1, wherein the license issuing unit divides the licensed period into a plurality of usage periods in a case where the licensed period is longer than a predetermined length and issues the license every usage period.

7. The license management system according to claim 1, wherein the license issuing unit sets, for a license, a time for issuing the second license as the starting time and a time when the usage period exceeds the predetermined length as the ending time.

8. The license management system according to claim 1, wherein the license issuing unit periodically checks the license information and issues the license for an application reaching a time for issuing the license therefor.

9. A license management method for managing a license for an application to be executed by an image forming apparatus, the method comprising:
storing license information including a licensed period for permitting to use the application;
issuing a license for the application having a usage period set based on the license information,
wherein, in a case where a second license for an application corresponding to a first license that is issued based on license information is to be issued based on different license information including a licensed period continuous to the licensed period of the first license, the license issuing sets a usage period such that the ending time of the first license can be continuous to the starting time of the second license to issue the second license.

10. A storage medium storing a program causing an information processing apparatus to manage a license for an application to be executed by an image forming apparatus, the information processing apparatus comprising:
at least a processor and at least a memory coupled to the at least the processor and having stored thereon instructions, when executed by the at least the processor, and cooperating to act as:
a license information storage unit configured to store license information including a licensed period for permitting to use the application; and
a license issuing unit configured to issue a license for the application having a usage period set based on the license information,
wherein, in a case where a second license for an application corresponding to a first license that is issued based on license information is to be issued based on different license information including a licensed period continuous to the licensed period of the first license, the license issuing unit sets a usage period such that the ending time of the first license can be continuous to the starting time of the second license to issue the second license.
